(19) United States
(12) Patent Application Publication
(10) Pub. No.: US 2011/0225243 A1
(43) Pub. Date: Sep. 15, 2011

(54) Method for global resources sharing, logically linked means and integrated functionality for solutions building

(76) Inventor: John Almeida, Richmond, CA (US)

(21) Appl. No.: 13/111,871

(22) Filed: May 19, 2011

Related U.S. Application Data
(63) Continuation-in-part of application No. 11/160,099, filed on Jun. 8, 2005, now Pat. No. 7,971,198.

(51) Int. Cl. G06F 15/16

(52) U.S. Cl. 709/205

(57) ABSTRACT

A method is disclosed for enabling sharing of software using logic links. Software may be an application or other code. Sharing occurs at runtime of a solution or an application. A first registered user uploads an application, an application page, and an application parameter which may then be used and shared with other users. User action seeking to share an application is done by the user selecting a logic link to the software. A second user adds a logic link in a solution that directs the integration of software sought to be shared. Thereafter, the second user may run the second solution with the application.

### CROSS-REFERENCE TO RELATED APPLICATIONS

This application is a continuation-in-part of U.S. application Ser. No. 11/160,099 filed 8 Jun. 2005, which is hereby incorporated by reference herein.

### FIELD OF THE INVENTION

In the field of data processing and software development, a method is disclosed for global resource sharing of logically linked (using if-then-else, case statement, compile embedded, etc.) and integrated functionality for solutions building.

### BACKGROUND ART

Since the early days of software development tools and techniques have been devised, created and integrated as part of the software building processes. One of the first techniques has been the creation of software routines and procedures where code repetition can be integrated at one location and used throughout the software development cycle by calling them without having to repeat the programming effort.

As the software development matured other techniques sufficed as well, like, the Dynamic Linking Library (DLL). With DLL many application solutions can use them, and they are linked to the application solution at runtime as needed.

Lately other software development techniques have been devised as well, like MICROSOFT dot NET technology where any computer language shares the resource where many DLLs are integrated at the resource level and available to any application and any solution at runtime.

For each step in the software development evolution, the unachieved goal has been to facilitate the development and integration of software logic by having more ready-solved software logic code blocks located at one location, at the resource level. Until now, no practical mechanism or method has previously been found to integrate all the development at the resource level

### SUMMARY OF INVENTION

A method is disclosed for enabling sharing of software using logic links. The method enables sharing of a software logic code block from a resources sharing container on a computer or server with an application at runtime of the application. A software logic code block logic links to the application. User action selects the logic link stored in a user resource. Registered users upload an application, an application page, and an application parameter which may then be used and shared. A computer or server computer is provides access to a resources sharing container, which includes a solution resource and an application resource and optionally a user resource. A solution is run upon action of a first user and the first user adds a logic link. When the first user selects the logic link, it runs the solution. A second user may add a parameter to change the way the solution operates or simply leave the solution as designed by the first user. The second user may then run a second solution and add a logic link to the application. Thereafter, the second user may run the second solution with the application.

Steps may include a computer assigning the user a user identification stored on the computer-readable medium; creating a resources sharing container on the computer-readable medium, the resources sharing container comprising: a software logic code block, a user resource, an application, and an application software page used with the application; the user resource comprising a logic link that connects the software logic code block to the application software page at runtime of the application so that the application will execute the software logic code block at runtime of the application software page; giving the user a choice to connect or disconnect the logic link, such that if the logic link: is disconnected, the application will not execute the software logic code block at runtime of the application; and the choice is stored and associated with the user identification in the user resource; and is connected, the application will execute the software logic code block at runtime of the application; and the choice is stored and associated with the user identification in the user resource; accessing the user resource associated with the user identification and if the logic link is connected, then executing the logic link of the software logic code block to the application software page upon the user launching of the application and upon the user running of the application software page; and presenting to the user a result from executing the logic link, upon executing the logic link.

### Technical Problem

No method currently integrates software development at the resource level by having ready-solved software logic code blocks that can be logically linked and shared by any application and any solution at the resource level. It previously had been an unachieved goal to facilitate the building of complete software solutions by simplifying the approaches used in software development and integration.

### Solution to the Problem

The solution is a method that creates completed solutions based on sharing of page-source code and settings parameters that can be logically linked at the global resource sharing level. The method is adaptable to providing value-added services, such as foreign language translation, page rendering, securities, to a broad base of solutions at the resource sharing level by integrating such services to solutions at the resource.

The development and integration of a software application into any solution is accomplished by logically linking the software application to the solution. Logic linking reduces the development cycle by enabling resource sharing so that applications and solutions can be developed and integrated by having them logically linked without repeating efforts. This method permits application and solution development to be located at one global resource location that can be easily shared over a network, such as the Internet, as needed.

### ADVANTAGEOUS EFFECTS OF INVENTION

Global resource sharing of logically linked software code blocks, application pages and application page settings enables sharing in-house over an intranet or globally over the Internet and on any device, portable, immobile, a combination of portable and immobile device, or a combination online and offline devices.

The method virtually eliminates the need to repeat manual programming efforts by providing logic-linking code block to pages, having these pages grouped into an application, then having these applications grouped into a solution. Instead, the method utilizes code blocks that integrate the applications into the solution upon a simple election to do so by the user. This frees the user from having to know how to program.

The method delivers greater advantages over time because as more logically-linked code blocks are developed, they enable others to integrate the same pages into applications and applications into solutions simply by using the global resource. Each new use builds more capability into applications and solutions, providing more functionality without any new programming effort or expense.

The method enables a user to supply a content page to replace another system content page that is common to all users and the new content pages look-and-feel and logic replacing the prior one.

The method using code-block logic linking enables virtualization of an application residing in a first resources sharing container and the virtualization occurring into a second resources sharing container. The virtualized application does not have the sensitive code of the original application, which permits replication of an application without compromising the security of the original applications hosting environment.

The method permits an application to be automatically associated with another application and once one of the two applications is linked to a user's application the associated application becomes linked automatically based on its association with the other linked application.

The method enables sharing settings parameters, foreign language translation, securities and other future solutions as well at the resource level and at a single global location. For instance, once a logically linked code block, application page, a settings parameters, interfaces, etc., are developed, their integration to a final solution can be done by simply dragging-and-dropping them to the resources sharing container.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates a resources sharing container for holding at least one logic functionality, application requirement, solution and preconfigured enhancement.

FIG. 1a illustrates a further embodiment of the resources sharing container.

FIG. 2 illustrates a resources sharing container with a logic-linking page.

FIG. 2A is a further illustration of FIG. 2 with an option node identification for a page.

FIG. 3 illustrates a logic-linking page.

FIG. 4 illustrates a resources sharing container with logic-linking page, setting, translation and template.

FIG. 5 illustrates a resources sharing container with a logic-linking page and a logic-linking logic code block.

FIG. 6 illustrates a table-representing FIG. 5.

FIG. 7 illustrates three functions for logic-linking logic code block to a page.

FIG. 8 illustrates the logic integration of an application (FirstApp).

FIG. 9 illustrates the logic integration of an application (SecondApp).

FIG. 10 illustrates the logic integration of an application (ThirdApp).

FIG. 11 illustrates the logic integration of a solution (GlobalSol).

FIG. 12 illustrates a resource table for all three applications and the solution (FIGS. 8, 9, 10 and 11).

FIG. 13 illustrates applications FirstApp, SecondApp, ThirdApp integration to solution GlobalSol.

FIG. 14 illustrates the database table integrating applications to the solution of FIG. 13.

FIG. 15 illustrates the three applications being linked to three solutions.

FIG. 16 illustrates a database table for the three applications linked to the three solutions of FIG. 15.

FIG. 17 illustrates a user replicating a solution to a user.

FIG. 17A illustrates a further embodiment of FIG. 17 and a second user replicating the same solution of FIG. 17 to a second user.

FIG. 18 illustrates a database table for the replication of FIG. 17 and FIG. 17A.

FIG. 19 illustrates two database tables in a relational state and they are FIG. 18 (top) and FIG. 12 (bottom).

FIG. 20 illustrates a database table with pages locations at resource folder.

FIG. 21 illustrates the resource for application (FirstApp).

FIG. 22 illustrates the resource for application (SecondApp).

FIG. 23 illustrates the resource for application (ThirdApp).

FIG. 24 illustrates the resource for solution (GlobalSol)

FIG. 25 illustrates node integration to a HTML page (Hyper Text Markup Language).

FIG. 26 illustrates the node integration of FIG. 25 along with the integration of settings-parameter.

FIG. 27 illustrates the displaying process for a menu.

FIG. 28 illustrates the displaying of a drop-down for the menu of FIG. 27.

FIG. 29 illustrates a link for launching a solution and it is the choice of the drop-down menu of FIG. 28.

FIG. 30 illustrates a further embodiment of the present invention where a resources sharing container has an application with distributed logic.

FIG. 31 is a further embodiment of FIG. 30 where the application is virtually hosted at remote locations and the parameters fetched from the hosting source location.

FIGS. 32-34 illustrate an application that may be associated with another application.

### DESCRIPTION OF EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention may be embodied as a method, software development technique of resources sharing container (100), or a computer program product. Accordingly, the present invention may take a form of an entirely software embodiment or an embodiment combining software and hardware. Furthermore, the present invention may take the form of a computer program product on a computer-readable medium (101) having computer-readable program code means embodied in the medium. Any computer-readable medium (101) may be utilized, preferably a non-transitory computer-readable medium (101), such as a hard disk, CD-ROM, optical storage device, or magnetic device.

The term computer is intended to be interpreted to include hardware that manages access to resources over a network. A computer is a physical device, and not just software, that is, it refers to a device that may be a desktop computing instrument, or portable computing instrument. Portable instruments include laptop computers, personal desk assistant devices, hand held telephones that access a network, or other such devices. The terms server and server computer are intended to refer to hardware, and not just software, that is, they refer to a device that manages access to data or resources stored on the device and accessed over a network. A server is networked to respond to requests from other computers.

Preferably, a user is registered to use the server or computer. Thus, the method may include the step of registering a user with the server or computer. Registration signifies that user data is saved on the computer-readable medium (101), preferably in the user resources (151) in the resources sharing container (100). Thus, the method may include the step of assigning the user a user identification (153) stored on the computer-readable medium (101).

Overview of the Resources Sharing Container

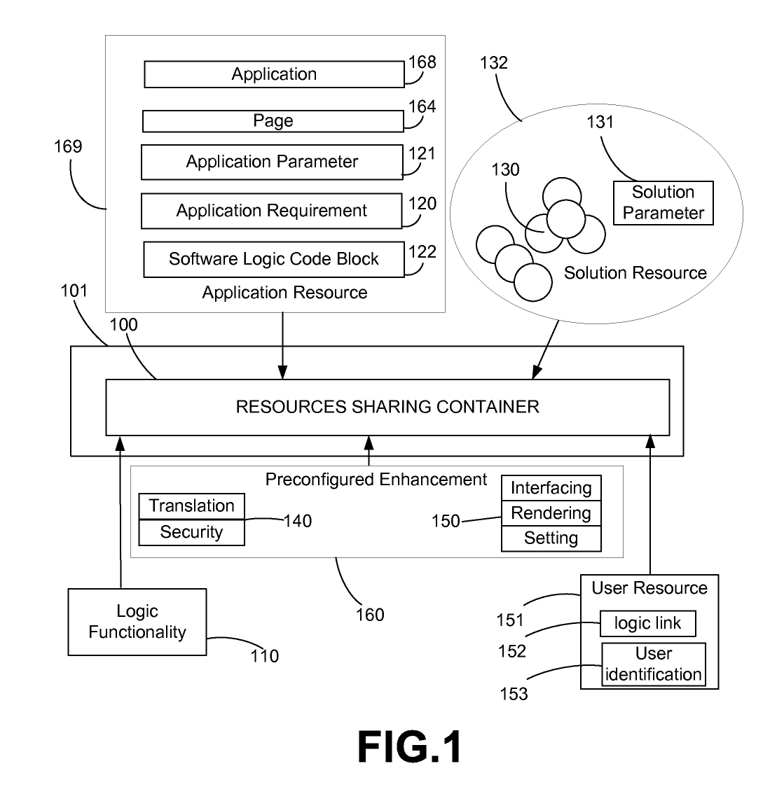

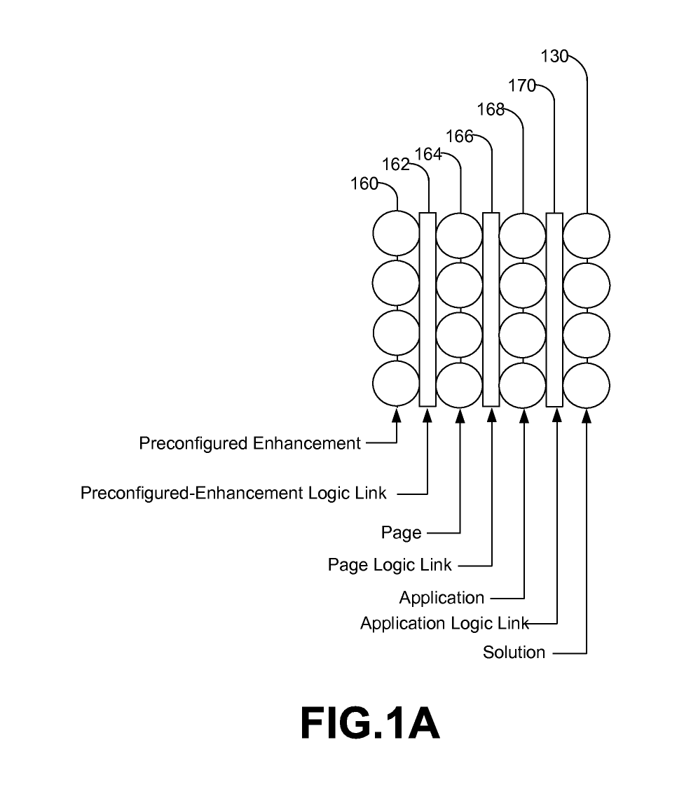

FIG. 1 and FIG. 1A illustrate the resources sharing container (100). The resources sharing container (100) is a defined portion of the computer-readable medium (101) that holds resources made accessible by the method of the invention. These resources may include one or more of a solution (130) resource (132); an application resource (169); and a user resource (151).

The resources sharing container (100) preferably contains all the required components (program code, settings, interfacing, rendering parameters, and others) for building robust logic-pages, one or more applications and their integration to one or more solutions. The components of the resources sharing container (100) may be user programmed and/or in-house programmed.

The solution (130) resource (132) includes: at least one solution (130), and preferably a plurality of solutions; and a solution (130) parameter (131) to control operation of the solution (130). There are preferably a plurality of solution (130) parameters.

The application resource (169) includes at least one: application (168), which is also referred to as program code or software; page (164) containing code operable in an application (168), the page (164), a logic-page or a program-code page; application parameter (121), which is a type of rendering parameter; and application resource (169). The application (168), application page; and application parameter (121) are preferably user supplied. The application resource (169) may also include a software logic code block (122), that is used by the application (168) or solution (130) at runtime of the application (168) or solution (130). The page comprises: an application page (302) used in an application, which is also referred to as an application software page; and a solution page (xxx), which is used in a solution.

A user resource (151) may also be included in the resources sharing container (100). The user resource (151) comprises a logic link (152) that connects the software logic code block to the page (164), that is the application software page, at the runtime of the application (168) so that the application (168) will execute the software logic code block at runtime of the application software page. A logic link (152) may be a page logic link (166), which links a page to an application (168); a application logic link (170), which links an application (168) to a solution (130); or a preconfigured-enhancement logic link (162), which links a preconfigured enhancement (106) to a page (164).

The resources sharing container (100) may include a database integrated by the user-supplied program code and/or in-house programmed code. The resources sharing container (100) further may comprise user supplied data or in-house supplied data stored in database tables, files or any storage means. Each page (164), that is, each program-code page, may be user uploaded, or any other means to supply programming-code instruction to a computer or server computer.

Each component in the resources sharing container (100) is available to be logic-linked to any other component in the resources sharing container (100). For example, logic linking is available to: a page (164), that is, an application page; an application (168); or a solution (130). If the component is user programmed, then the user programmed component is uploaded by a first user to the resources sharing container (100). Thus, the method of the invention includes a step of receiving from the first user: an application (168), more specifically, a first-user application; a page (164), more specifically a first-user-application page; and an application parameter (121), more specifically a first-user-application parameter.

A component may be stored within a subdirectory, a file, a database or any other storage means of the resources sharing container (100). The first user request that the server or computer adds one or more desired logic links. Thus, a preferred method includes a step of adding a logic link to the first-user-application within the first solution upon a request from the first user. To run a first solution with the logic link, the user selects the logic link to activate it.

Thus, this method implements a step of causing to run within the first solution and on the server computer the first-user application subject to the first-user-application parameter and the first-user application page, said causing initiated by the first-user action to select said logic link within the first solution.

An embodiment may also include a step of giving the user a choice to connect or disconnect the logic link (152), such that if the logic link: 152) is disconnected, the application (168) will not execute the software logic code block (122) at runtime of the application; and the choice is stored and associated with the user identification (153) in the user resource (151); and if the logic link is connected, the application (168) will execute the software logic code block (122) at runtime of the application (156); and the choice is stored and associated with the user identification (153) in the user resource (151).

Once the user makes the choice to connect or disconnect, the method preferably includes a step implemented by a computer or server computer of accessing the user resource (151) associated with the user identification (153) and if the logic link (152) is connected, then executing the logic link (152) of the software logic code block (122) to the page (164) that is the application software page, upon user launching of the application (168) and upon the user running of the application software page.

Once in the resources sharing container (100), the component is available to be shared by a second user, via logic-linking, by any page (164), application (168) or solution (130) present in the resources sharing container (100). The second user may change the settings or parameters of the logically linked page (164), application (168) or solution (130) and may use a second solution different from the solution (130) used by the first user. Thus, a preferred method includes a step of enabling the second user to add a second-user-solution parameter to the solution (130) resource to govern how the second solution is run.

Preferably, the first user runs the solution (130) with the uploaded application. Thus, a preferred method includes a step of running a first solution in the plurality of solutions upon action of the first user, said running controlled by the first-user-solution (130) parameter. Changes and upgrades to the component may be applied to the component only once and have effect in each page (164), application (168) or solution (130) to which it is logic linked. This avoids multiple distribution efforts and expenses associated with new software versions.

When a second user runs a solution (130) (for example a first-user solution or second-user solution), the second user is free to use the first-user application and parameters as they are or as changed by him. Thus, a preferred method includes a step of running the second-user solution upon action of the second user, said running controlled by the first-user-solution parameter if no second-user-solution parameter is present, or by the second-user-solution parameter if the second-user-solution parameter is present in the solution (130) resource.

Once the server computer or computer runs the solution, the method preferably includes a step of presenting to the user a result from executing the logic link, upon executing the logic link.

By enabling logic-linking at the resource level, once a solution (130) or an application (168) is integrated, it can be virtually replicated by simply registering it to a different user. The user may be an individual or a company owner of the solution (130) or the application. The first solution or the first application becomes a template-mode for its virtual replication to a second user or second-user solution. All that is needed is for the second user to add a logic link to the desired component. It is like having a single car that can be driven by the whole family at the same time at different locations and tailored to each individual family-member as per each individual tastes and preferences. Thus, a preferred method includes a step of adding the logic link to the first-user-application within a second-user solution in the plurality of solutions upon a request from the second user.

Moreover, the resources sharing container (100) has all of the components to integrate program code such as settings, interfacing renderings, and other parameters and related preconfigured enhancements needed to create and display a page (164) integrated to an application (168), and the application (168) integrated to one or more solutions. The components may be located in a database, be user supplied files or may be other user input. Once a second user adds a logic link to a component in the resources sharing container (100), and then activates that link, the server or computer implements a step of causing to run within the second solution and on the server computer the first-user application subject to the first-user-application parameter and the first-user application page, said causing initiated by the second-user action to select said logic link within the second solution.

Each part of the resources sharing container (100) is like a plug in, but may not be associated to any page (164), application (168) or solution (130). Therefore, they are independent when made and ready to be plugged in into a page (164), application (168) or solution (130) as required. The plug-in mechanism functions like an electric switch. Except it is a logic switch, switching program code, settings, interfacing, etc., in and out as needed.

Furthermore, the resources sharing container (100) can be compared to an electrical wiring system and all the devices are powered once plugged-in and connected thereto. Each device connected to an electrical wiring system usually has a switch of some sort, to switch it on and off. At the resources sharing container (100), the switching is done with the use of program logic.

An example may be helpful using this analogy of devices connected to the electrical wiring system. If these devices were integrated at the resources sharing container (100), each device plugged-into the wiring system may have its own unique shape, size, color, and so on. If the device were a light bulb, it may be any size, shape, color, intensity, and so on. The light bulb is a single device and it may be replicated, produce a different color, reshaped, resized, etc., according to each one needs and preferences, except in the case of the resources sharing container (100) the replication is virtual and takes place by changing parameters rather than replicating the physical light bulb.

FIG. 1 illustrates the resources sharing container (100), the logic functionality (110), the application requirement (120) and the solution (130). Translation and securities (140), and interfacing, renderings and settings (150) are preconfigured enhancements (160) to the resources sharing container (100). They can be part of the resources sharing container (100) (be embedded to the resources sharing container (100) pages, applications and solutions), like translations and securities, or, they can be user supplied, like settings, interfacing and renderings, program-code page and other components used by the application (168), page (164) or solution (130). In the case of translations and securities, any solution (130) may use them and they would be integrated at the resource level. All others are user supplied and will differ for each solution (130). Many other enhancements can be created and integrated as well.

The logic functionality (110) contains all the code-logic, program code, logic-linking nodes (a node is the same as a logic link (152)), applications and solution (130) settings, translations, securities, etc., and they may be accessed using logic-linking to any page (164), application (168) or solution (130). The application requirement (120) is a user defined need for the integration of one or more pages to one or more applications, and the integration of an application (168) to a solution (130). The solution (130) is the final user-defined solution (130) and it is typically the byproduct of at least one logic functionality (110) and application requirement (120).

FIG. 1A shows a preconfigured enhancement (160), which is linked/available to page (164) through preconfigured-enhancement logic link (162). Some preconfigured enhancements are embedded in the resources sharing container (100) while others are user supplied and available to the application (168) uploaded by the user, or to any other application that may happen to use them. Page (164) is linked to application (168) through page logic link (166), and application (168) is linked to solution (130) through application logic link (170).

As it is with any software solution or application, a preconfigured enhancement (160) is programmed as components and later integrated (linked) to code-pages at machine runtime. The two most popular are DLL (dynamic linking library) and the latest MICROSOFT.NET. They both are linked at runtime. DLLs are integrated at the operating system level and are registered with the operating system and they can be shared by any application, that is, they are dynamically linked to applications at runtime. The .NET shares some similarities with its predecessor DLL. It is linked at runtime but it is part of the .NET resource infrastructure that allows the creation of binaries (compiled code that is read by a binary interpreter) and it is language independent.

Unlike DLLs and .NET, logically linked pages, application (168) and solution (130) are not dynamically linked. The linking process is done automatically by the resources sharing container (100) and it is based on each application requirements by logic linking the page (164), application (168) or solution (130) at the runtime of the application (168) or solution (130). That is the reason it is called a logic link (152). The resources sharing container (100) can contain all kind of parameter-based files, database tables, program code block and many other techniques can be developed and used as well. The contents of the resources sharing container (100) may also be referred to as logic-linking components. Once these logic-linking components are integrated at the resources sharing container (100) they are free to be logic-linked to any solution (130) and not being specific to any page (164), application (168) or solution (130).

Logic-Linking Pages Within the Resources Sharing Container.

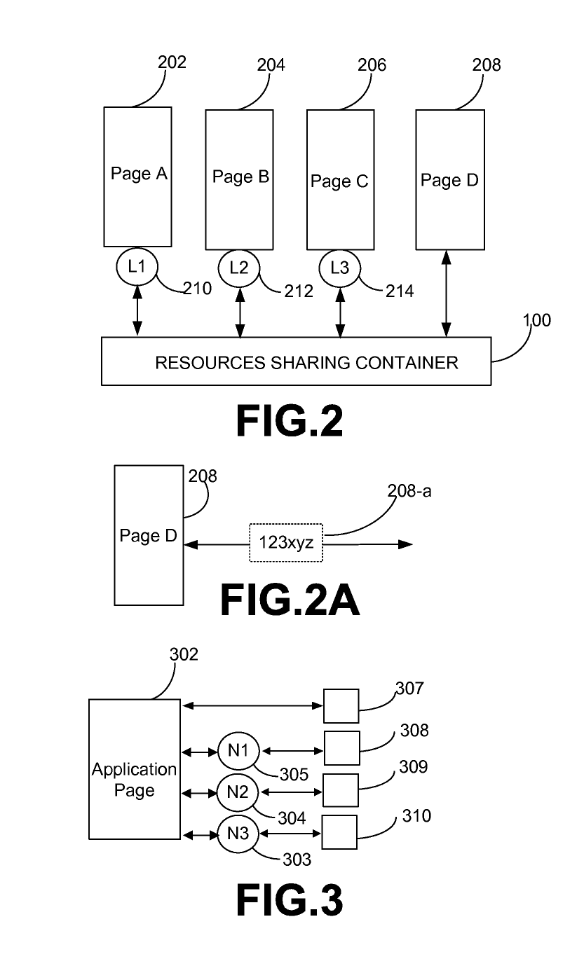

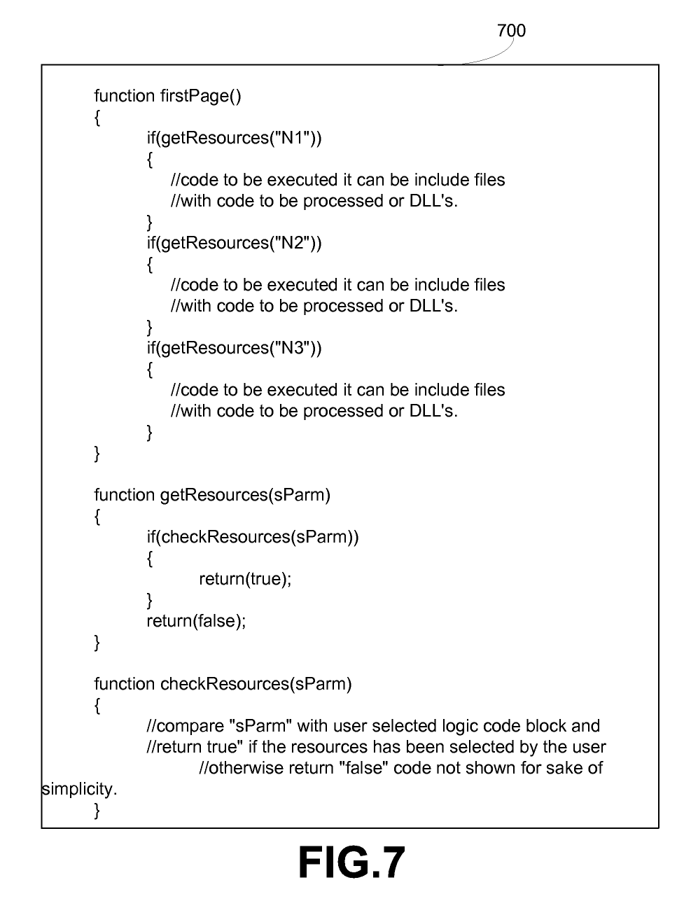

FIG. 2 illustrates logic linking of pages that are within the resources sharing container (100). Page A (202) is linked to the resources sharing container (100) by logic-linking node L1 (210). The logic linking mechanism can be an if-then-else, case blocks or any other form for integrating code to a page (FIG. 7 illustrates an if-then-else method). It can also be integrated as part of the resource itself. The same explanation applies to Page B (204) and it has the logic-linking node L2 (212) and Page C (206) has the logic-linking node L3 (214). Page D (208) differs from the other pages, it does not have any logic-linking node, it is integrated into the resource and it can be used by any application or solution (130). It can be a page (164) common to any application (168) and/or solution (130), such as a login page.

A page (164) that is common to all applications like a login page may be changed by a user by simply uploading a new login page with a new logic or look-and-feel. The new user-provided common page has an optional identification that is incorporated as part of the page identification in the resources sharing container (100). This arrangement is illustrated in FIG. 2A and it illustrates the page D (208) of FIG. 2 and the optional nodes identification (208-a) and it has the value 123xyz but it can be any kind of value without departing from the true spirit of the invention. The nodes identification will reside in the resources sharing container (100) and it may be in a value in a database column identifying a row with a path address to where the common page source code resides (further explained once FIG. 20-24 are explained), the nodes identification may reside in any kind of storage where information may be stored thereto and not limited to a database.

For example, assuming a common page is a login page. A user uploads a program file to the resources sharing container (100) with a new look-and-feel for the new login page and it is stored in a folder-path c:/rsc/usera/login.asp. The first user or owner of the new login page may name the page as Beautiful Login Page. The link of the commonly used page, like a login page, may not change at all and the new page will simply use the prior link, or the link may change and the new page may also incorporate a new link for activation of the new login page. The resources sharing container (100) will present the user with a choice for a logic link (152) to the desired login page.

In another example, after user X uploads the page (164), user X and any other user that wants to integrate the page (164) into the user's application, then the user doing the integration will access a system page of the resources sharing container (100) and select a page titled Beautiful Login Page to be linked to the user's application or solution (130), the page (164) will have the nodes identification 123xyz associated with the page. Once an application that happens to have the new page Beautiful Login Page is executed by the resources sharing container (100), the resources sharing container (100) will fetch the page-nodes identification 123xyz then the page location in the resources sharing container (100) c:/rsc/usera/login.asp and present the new look-and-feel for the user's application or solution (130), thus replacing the prior login page. If the user later on accesses the resources sharing container (100) and resets the login page, the login page that is a common integrated page to the resources sharing container (100) will replace the current page Beautiful Login Page, that is, the original login page will replace the users assigned login page (Beautiful Login Page). So the resources sharing container (100) has a common login page and a user selects another page Beautiful Login Page, and Beautiful Login Page replaces the common login page. Later on the user may reset the login page node and the common login page will replace the Beautiful Login Page.

Preferably, the method comprises providing a resources sharing container (100), which comprises a fist user registered with the resources sharing container (100), an application and a code-page (content page) to be processed by a computer. The code-page may be system or user provided and available to all applications in the resources sharing container (100). The resources sharing container (100) further comprises a code-reference associated with the code-page and once the code-reference is processed by the computer it cause the resources sharing container (100) to identify the first code-page at the resources sharing container (100) and the resources sharing container (100) logic-link the first code-page to the user's application.

This method further comprises a second users registered with the resources sharing container (100) and the second user providing second code-page that a user may link to replace a user's application and the second code-page will replace the logic and the look-and-fell of a prior code-page that was linked to the user's application. The first user logic-linking the second code-page into the first user's application by selecting the second code-page and the code-reference. Receiving at the server computer an access by the first user to the resources sharing container (100), the server computer processing the code-reference and the server computer causing the resources sharing container (100) to logic-link the second code-page into the first user's application and automatically replacing the logic and the look-and-feel of the first code-page. Such replacing of the first code-page may not cause the resources sharing container (100) to replace the link associated with the first code-page. Thus, the link may not be changed but the code-page will be replaced by the new second code-page. The method further comprising means for the first user to reset the code-reference and the first code-page replacing the second code-page, thus resetting the logic and the look-and-feel to first code-page that is the original (common to all applications) provided code-page to be used by the all applications of the resources sharing container (100).

Logic-Linking Nodes Within a Page

FIG. 3 is a further embodiment of FIG. 2. FIG. 3 illustrates a page with its logic-linking node. As with pages that are linked to applications through logic-linking nodes, pages have logic-linking mechanism as well and they allow the integration of code-logic blocks (piece of program code). Application page (302) has one ready linked code-logic block (307). Node N1 (305) links code-logic block (308); node N2 (304) links code-logic block (309) and node N3 (303) links code-logic block (310). By having code-logic blocks that are logically linked to pages, it allows any common used code block to be integrated in more than one page, thus, reducing code replication and maintenance.

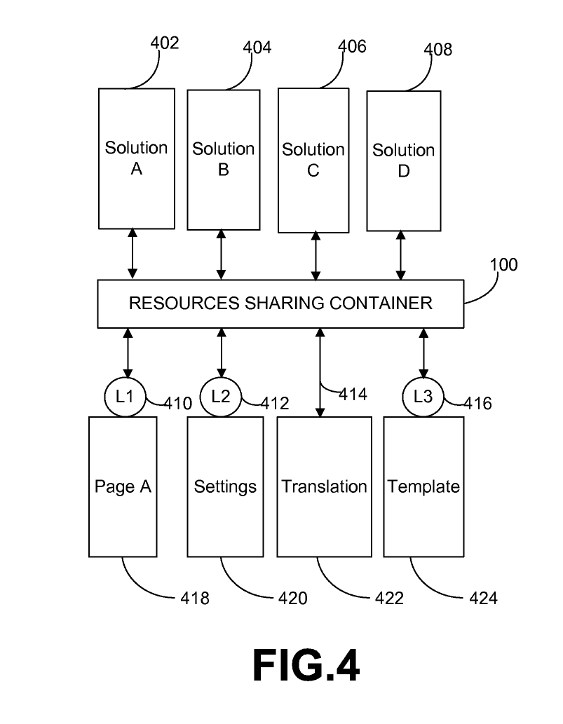

FIG. 4 illustrates the resources sharing container (100) along with logic-linking pages of different functionalities. Page A (418) is a program logic-page and it has a logic-link L1 (410), also referred to as logic-linking node L1; the second page is a page with Settings (420) (user or system supplied) and it has logic-link L2 (412), also referred to as logic-linking node L2; the third is a means for Translation (422) and it is integrated at the resource level and it is indicated by the double arrow line (414); finally, there is a Template (424) (user or system supplied) and it is logic-linked by logic-link L3 (416), also referred to as node L3.

The Settings (420) and Template (424) may both be user or system supplied. Both of them will be integrated to the user's solution (130) and not having any effect to any other solution (130) therewith.

Sharing of the Resources Sharing Container by Solutions

In FIG. 4, there are four solutions (alternatively, it can be four applications as well). The first one, Solution A (402), and it has a double-arrow, which indicates that it is already logic-linked, since it has already been explained at FIG. 2. For simplicity, the logic-link is not shown.

Page A (418) is linked through logic-link L1 (410) and it can be used, logically linked, by any of the solutions in FIG. 4. Settings (420) shows logic-link L2 (412) and Template (424) shows logic-link L3 (416). These two are logically linked to their respective user's solution and not necessarily linked to the resources sharing container (100), although they can be linked to resources sharing container (100) as well. Translation (422) is linked (integrated/embedded) to the resources sharing container (100) and shown by the double arrow line (414). Translation (422) is available to Solution A (402), Solution B (404), Solution C (406), and Solution D (408) in the resources sharing container (100). The purpose of the arrangement in FIG. 4 is to illustrate that more than one solution can be integrated by having the same pages logically linked to any one of them in any arrangement.

Database Table Representing the Resources Sharing Container

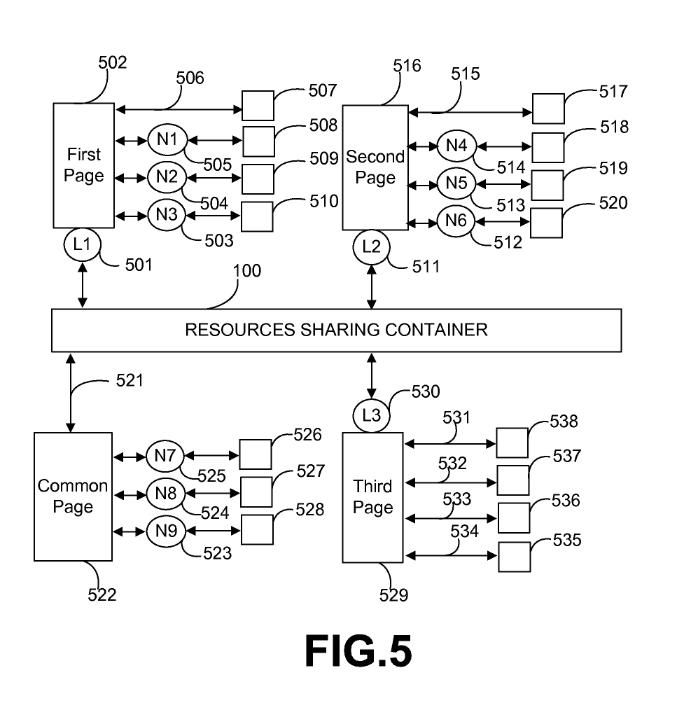

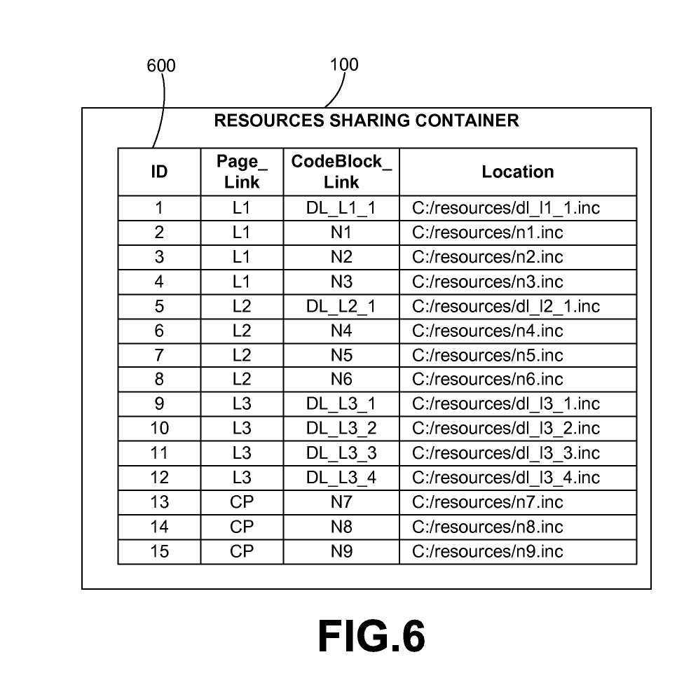

FIG. 5 and FIG. 6 illustrate the resources sharing container (100) and are best explained together. There are four pages in FIG. 5 and FIG. 6 illustrates a database table (600) in the resources sharing container (100). The first column of the database table (600) is an ID or identification of the row. In the first row (1) at the Page_Link column is the value of L1, which represents the logic-link node L1 (501) of First Page (502) of FIG. 5. In the first row (1) at the CodeBlock Link column is the value of DL_L1_{—}1, and it represents the two-arrow link (506) shown in FIG. 5. Any time a value in this column has the starting value of DL it means that the logic code block is directly linked to the page or application. In this case, it is part of the page, it can be any other value as well. In the first row (1) at the Location column is the address in memory, that is, the folder location in memory (C:/resources/dl_l1_{—}1.inc) where the logic code block (507) can be found.

In the second row #2 (identification column) at the Page_Link column is the value of L1, and it is the logic-link node L1 (501) of First Page (502) of FIG. 5. Next column is the CodeBlock_Link column and it has the value of N1, and it represents the N1 (505) of FIG. 5. The last column, Location has C:/resources/n1.inc and it is the folder location where the logic code block (508) of FIG. 5 is located. The last three rows of the database table show the value of CP for the Page_Link column, and it is the abbreviation for Common Page (522) of FIG. 5. All other rows in the database table are self-explanatory and anyone skilled in the art will be able to follow the above explanation along with what has already been explained so far and fully understand their meanings.

Logic-Linking Method In a Page.

FIG. 7 illustrates how to implement the logic-linking mechanism that has been discussed so far. It uses a function firstPage( ) and it can be called from any page, and once called its if-then-else will include the code based in the application requirements selected by the user. The code can be in the form of DLL, include file, objects from database, etc. As it has been explained before, other methods can be used as well for the same purpose, like case statements, logic part of the resources sharing container (100), or a complier can be developed for the same purpose and be used to compile the code for each application and solution (130) as they are fetched for the first time by the computer.

FIG. 7 illustrates three functions for logic-linking logic code block to a page (164). The first if statement is the function firstPage( ) and it is if(getResources(N1)). As the functions code is processed the function getResources(sParm) will be called and the parameter of N1 will be passed on to the function getResources( ) and it will in turn call checkResources( ) function and pass the N1 parameter to it. The checkResources( ) function will use the received parameter N1 and compare it to the resource and if the user has selected the node N1, that is, the node N1 is part of the user's resources. If it is, the function checkResources( ) will return true to getResources( ) and getResources( ) will return true to the firstPage( ) function, thus, finalizing the process, and the code within the if statement if(getResources(N1)) will be included into the page.

Applications and Solutions Requirements

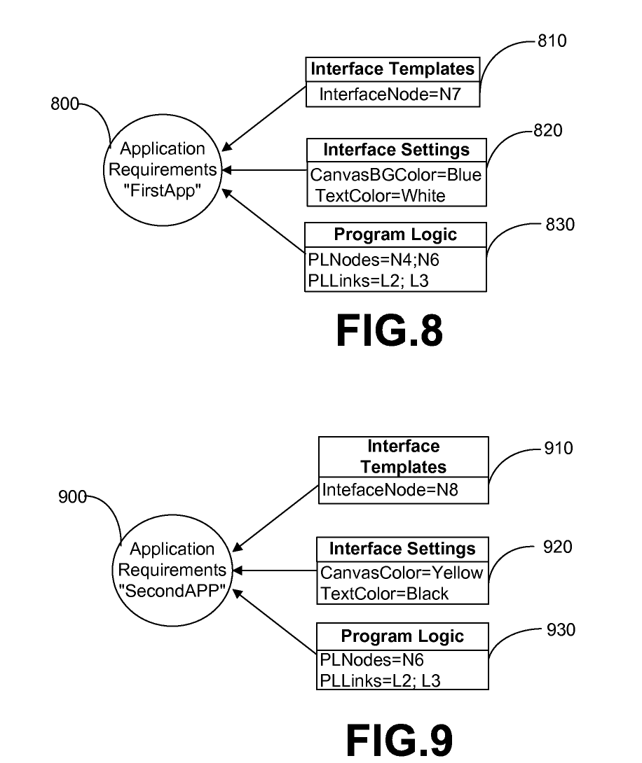

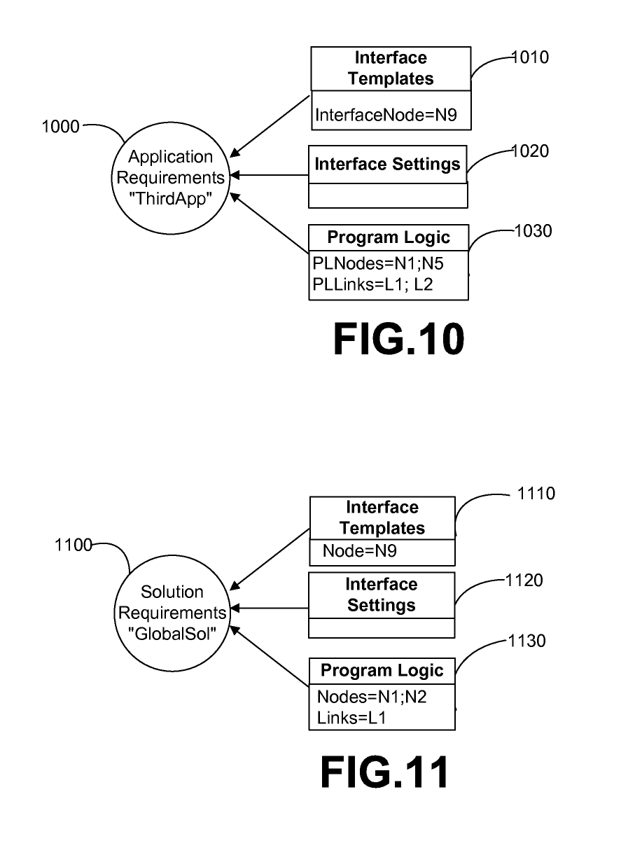

FIG. 8 and FIG. 9 illustrate the supplying of Interface Templates, Interface Settings and Program Logic for two applications. FIG. 10 illustrates the same method for a solution.

FIG. 5 and FIG. 8 are related and are discussed together. FIG. 8 illustrates the Application Requirements FirstApp (800) and it has InterfaceNode=N7 for Interface Templates (810), and, it is the node N7 (525). FIG. 5 logically linked to Common Page (522) shown in FIG. 5. Interface Settings (820) have CanvasBGColor=Blue and TextColor=White and they are interface renderings. They can user supplied by uploading a file, or they can be integrated to the resources sharing container (100) from a database table. Its use will fully explained as we review 26. Following is the Program Logic (830), and it has the PLNodes=N4; N6 and they are N4 (514) and N6 (512) of FIG. 5 logically linked to Second Page (516) of FIG. 5; PLLinks=L2; L3 are logic link L2 (511) and logic link L3 (530) of FIG. 5.

The application that integrates the above resource (FirstApp) now has the value SecondPage (516) with code logic block (517) already integrated (515) to the second page (516), code logic N4 (514) linking code block (518) to second page (516) and code logic block N6 (512) linking code block (520) to second page (516). It also has the Third Page (529) and all of its code logic blocks.

The means for supplying these requirements to the resources sharing container (100) may be in the form of check boxes, uploaded files, part of the resources sharing container (100) itself or any other user-supplied means. Other kind of requirements can be included when needed, as well.

The same explanation applies to FIG. 9, FIG. 10 and FIG. 11 and anyone skilled in the art will be able to follow the explanation given for FIG. 8 and fully understand them as well. FIG. 10 and FIG. 11 do not have any value for the Interface Settings (1020) and (1120) respectively. It simply means that the application ThirdApp (1000) and the solution and its requirements, GlobalSol (1100), did not require any interface rendering.

Once these application requirements are supplied to the resources sharing container (100), they can be stored in a database table or any other storing means. Also, the process of supplying requirements can be done with check boxes, pull down menus, drag-and-drop, etc.

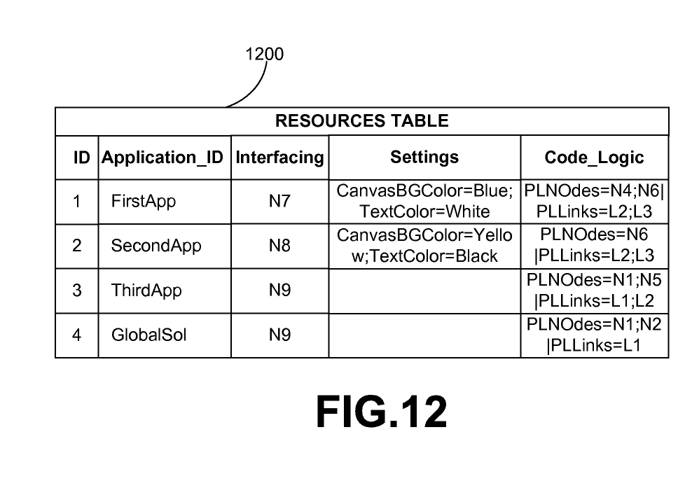

Referring to FIG. 8 and FIG. 12, FIG. 12 illustrates a database table for the applications and solution (130) of FIG. 8, FIG. 9, FIG. 10 and FIG. 11. Referring to the database table column identification first row #1. Under the column Application_identification and on identification row #1, is FirstApp and it is Application Requirements FirstApp (800) in FIG. 8. The next column to the right is Interfacing and under row #1 is entry N7 and this is the same as InterfaceNode=N7 of Interface Template (810) in FIG. 8. The next column is Settings and on row #1 and the entry is CanvasBGColor=Blue; TextColor=White. This is the same as CanvasBGColor=Blue and TextColor=White of Interface Settings (820) in FIG. 8. Finally, the column Code_Logic and on row #1 are the values PLNodes=N4; N6 |PLLinks=L2; L3. These are the same as PLNodes=N4; N6 and PLLinks=L2; L3 of Program Logic (830) in FIG. 8.

Row #2 of table (1200) relates to FIG. 9; row #3 relates to FIG. 10 and row #4 relates to FIG. 11. They use the same principle as for the row #1 and anyone skilled in the art will be able to follow the above explanation and fully understand them as well.

Linking Applications to Solutions

Once application requirements are supplied to an application and it has all of its necessary logic requirements for its support then it is ready to be logically integrated to one or more solutions and the receiving solution will be able to launch them as needed.

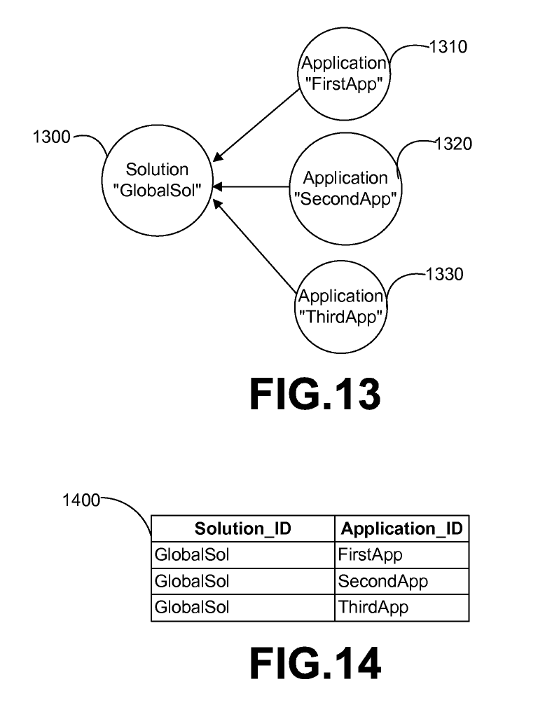

FIG. 13 illustrates Solution GlobalSol (1300) having three logic-integrated applications: Application FirstApp (1310), Application SecondApp (1320) and Application ThirdApp (1330).

FIG. 14 illustrates a database table (1400) with two columns: Solution_identification and Application_identification. They represent what has been discussed for FIG. 13. The column Solution_identification indicates GlobalSol and it has three applications (FirstApp, SecondApp and ThirdApp) linked to it. Once again, as with the supplying of application requirements, the linking of applications to solutions can be done with check boxes, pull down menus, drag-and-drop, etc.

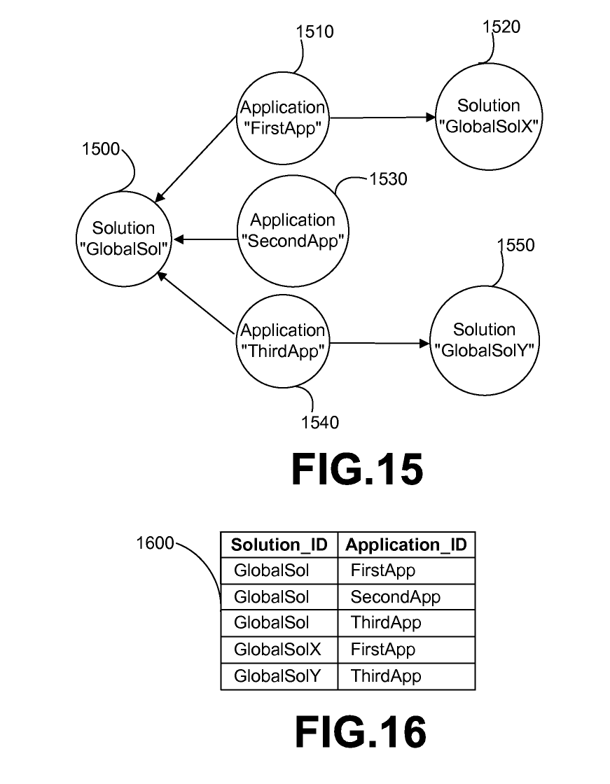

FIG. 15 is a further embodiment of FIG. 13 and in addition, it illustrates Application FirstApp (1510) and Application ThirdApp (1540) being integrated to more than one solution. Application FirstApp (1510) is integrated to Solution GlobalSol (1500) and Solution GlobalSolX (1520); Application ThirdApp (1540) is integrated to Solution GlobalSol (1500) and Solution GlobalSolY (1550).

FIG. 16 illustrates data base table (1600) and it illustrates application integration to more than one solution discussed above for FIG. 15.

In the database table (1600) of FIG. 16, the first three rows and at the column Solution_identification has GlobalSol at each row, the next column, Application_identification has the three applications: FirstApp, SecondApp and ThirdApp (rows #1-#3). They are also Application FirstApp (1510), SecondApp (1530) and Application ThirdApp (1540) of FIG. 15. The last two rows are for Solution GlobalSolX (1520) and solution GlobalSolY (1550). Solution GlobalSolX (1520) has FirstApp (Application_identification column) and it is Application FirstApp (1510) of FIG. 15. Finally, GlobalSolY (1550) has ThirdApp (Application_identification column) and it is Application ThirdApp (1540) of FIG. 15.

The Process of Virtual Replication of Solutions

Once requirements are supplied to an application and the application is logically integrated to a solution (130), the solution (130) is ready for the final replication and use by any number of users. This process is much like the replication of software in CDs or any other recording media. The only difference is that, the replicating process is done virtually. Since the application-logic, application requirements (120), solution (130) and its respective applications reside in the resources sharing container (100). They can be replicated by just assigning the solution (130) to a user.

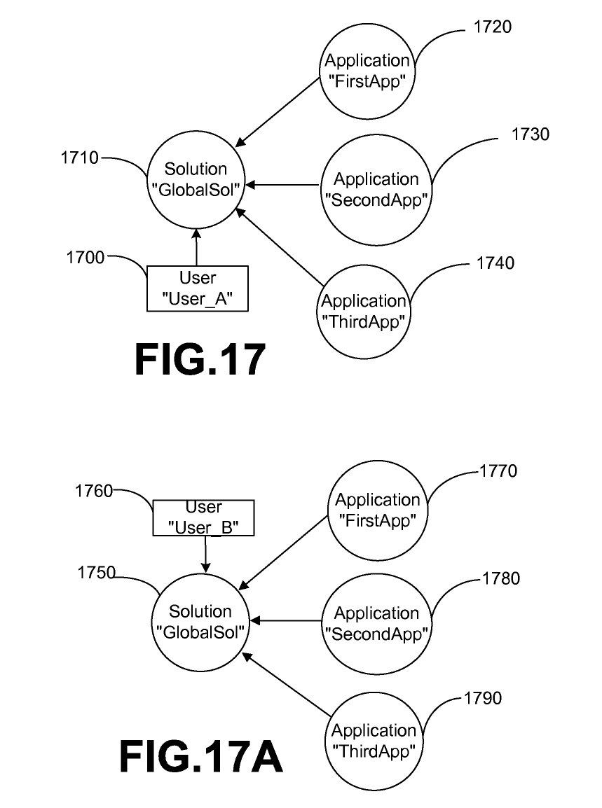

FIG. 17 and FIG. 17A illustrate the same arrangement of FIG. 13, except, this time the same solution along with its application have been replicated to two users. FIG. 17 illustrates the Solution GlobalSol (1710) is assigned to User_A (1700) along with its applications FirstApp (1720), SecondApp (1730) and ThirdApp (1740). FIG. 17A illustrates the Solution GlobalSol (1750) is assigned to User_B (1760) along with its applications FirstApp (1770), SecondApp (1780) and ThirdApp (1790).

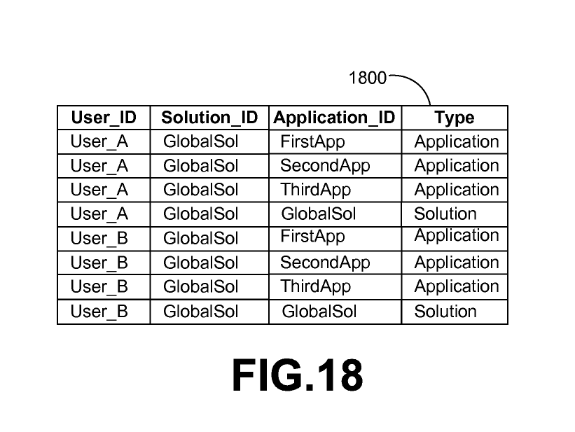

FIG. 18 illustrates the same table of FIG. 16 with two new columns added: User_identification and Type columns. The User_identification column illustrates the same solution along with its application assigned to two different users: User_A and User_B in a virtual replication mode, and they are, User_A (1700) of FIG. 17, and, User_B (1760) of FIG. 17A. Finally, the column Type indicates what kind, applications or solutions, the resource identities are. In the first four rows of the database table (1800), the first three rows have the value for Application and it is for type Application for FirstApp (1720); SecondApp (1730) and ThirdApp (1740) 17. Row #4 has the value Solution and it is for the solution GlobalSol (1710) of FIG. 17.

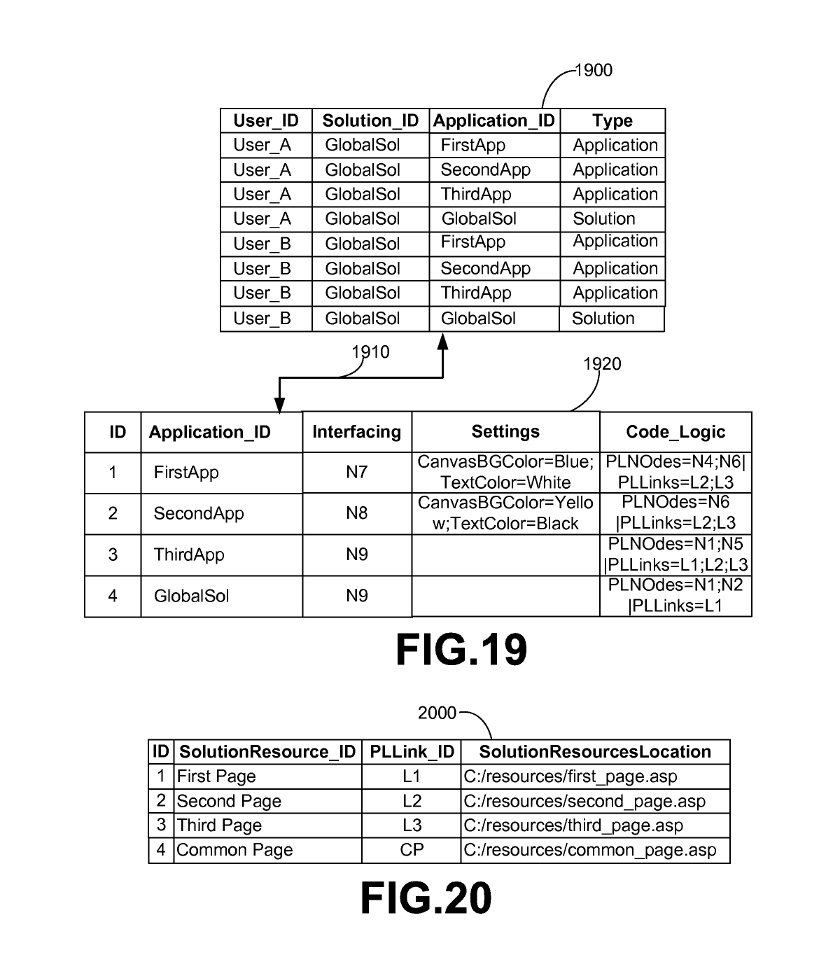

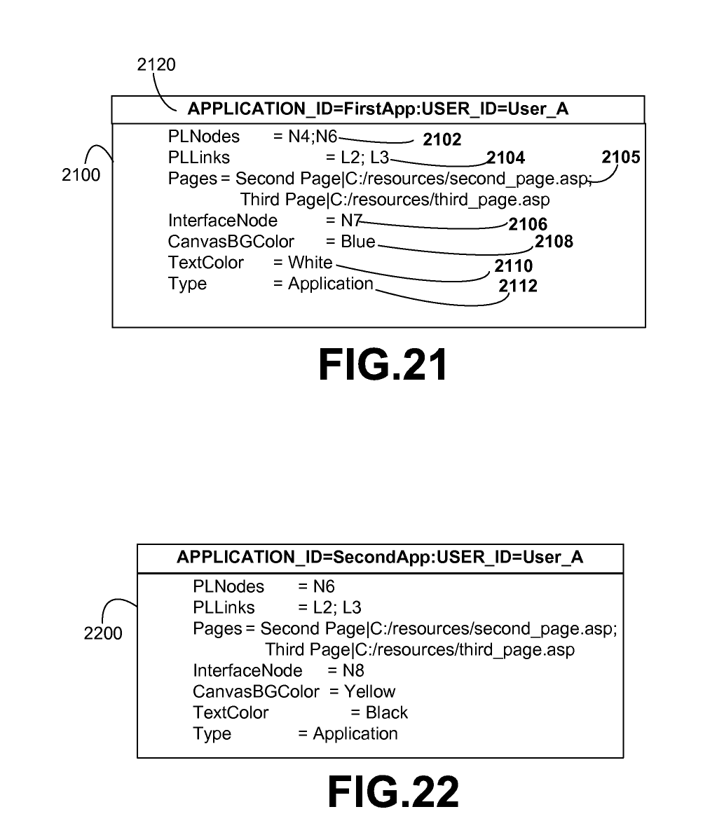

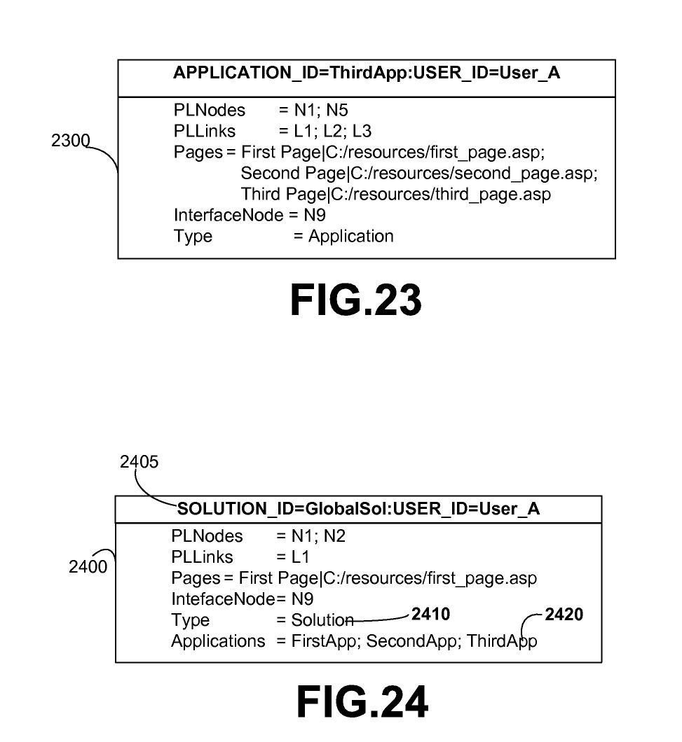

FIG. 19 shows two tables drawn from FIG. 18 and FIG. 12 and showing a database tables relation (1910) by the Application_identification column of each table. FIG. 19 top database table (1900) (top database table) has User_identification column which identifies the user assigned to a solution. Once a user logs in, the resources sharing container (100) initiates a search for the user at the User_identification, then retrieves the user's solution based on the Appliction_identification of the resources table (1920) (bottom database table). The application and solution resources are retrieved, the resource for each user along with the user's solution is created. This process is also below in reference to FIG. 21, FIG. 22, FIG. 23 and FIG. 24.

After a user logs in and the solution for the user is loaded and resources are created, they are presented for the user's selection and can be of any form for selecting an application within the user's solution. A linking means is further illustrated below.

FIG. 19, top database table (1900) has two users illustrated at the User_identification column: User_A and User B. Assuming that User_A is logged in and the applications FirstApp, SecondApp, ThirdApp and GlobalSol are assigned to the logged-in user. Since the two tables are related, top database table (1900) and resources table (1920), a group of links will be created for FirstApp, SecondApp and ThirdApp. The GlobalSol (forth row) can be programmed to behave differently than the previous three. It can be programmed to load any requirement to be used by the solution, such as loading database tables, settings, interfacing, etc., plus the links for applications FirstApp, SecondApp and ThirdApp.

The user may select any of the application links, for example, assume that the first link, FirstApp is selected. Referring to resources table (1920) identification #1 (first row) and last column (Code_Logic). At the Code_Logic column there is the value of PLLinks=L2; L3. The program logic fetches the value PLLinks=L2; L3 and extract the values L2 and L3. Then, the program logic formulates a Structured Query Language (SQL) statement (not shown for simplicity) and searches the column PPLink_identification of database table (2000) of FIG. 20, thus, fetching the rows #2 and #3 of identification column. These two rows have the values L2 and L3 at the PLLink_identification column, respectively. Following these two rows at Solution ResourcesLocation column, there is the code logic for each page, C:/resources/second_page.asp for L2 and C:/resources/third_page.asp for L3. The previous two logic-links: L2 and L3 are the logic-link L2 (511) and logic link L3 (530) of FIG. 5.

The invention may be implemented in other ways. For instance, the column Solution ResourcesLocation may be substituted with a column that represents the location of applications instead of the locations of solutions. A user implementing the invention may link an application to another application to form a solution and the system will therefore fetch the file-code representing the application or the applications page and execute the fetched application or the applications page. Database table (2000) can be substituted with a table related to applications and the pages and the column can be associated with applications instead of solutions, or any combination not described herein.

In review of a preferred method, the user selects the solution link for GlobalSol and FirstApp, SeconApp and ThirdApp links are displayed. The user selects the link for FirstApp and the links for Second Page and Third Page (Solution Resource_identification database table (2000)—FIG. 20) are displayed. The user selects a link, for example, the Second Page link (second row of database table (2000)—FIG. 20). The second_page.asp located at the folder named resources at drive c: is processed.

The last row of FIG. 20 (PLLink_identification column) database table (2000) and identification #4 shows the value of CP. It represents a Common Page (522) FIG. 5. Thus, the page is directly connected to the resources sharing container (100) and available to all applications and solution therein.

The applications and solution may be any commercial solution, such as accounting and the applications could be accounts payable, accounts receivable, inventory, etc., and they are part of the solution accounting.

Creation of Resources

In some embodiments, there are two-kind of resources: application resource and solution resource, and they both can be replicated and assigned to a user for the application and the solution holder of the application(s). The replication process takes place at runtime as the resources sharing container (100) retrieves various parameters from storage sources like: database tables, files, and other means as well, it process them and they are used to create the new application and/or solution for the requesting user.

The application resource contains all the necessary information to launch the application and the solution resource contains all the necessary information to launch itself along with all of its applications as well. It is at this time that logic linking takes places and information is loaded from files, also, fetched from database tables.

FIG. 21 illustrates the creation of a resource. Each element of the resource is extracted from a database table that has already been discussed. Focusing on resources for the FirstApp for the user Uuser_A 2120 at the resource (2100), the first and second line PLNodes=N4; N6 (2102) and PLLinks=L2; L3 (2104) are retrieved from the first row of the Code_Logic column of the resources table (1920) of FIG. 19. The third line (2105), Pages=Second Page|C:/resources/second_page.asp; Third Page|C:/resources/third_page.asp are retrieved from the database table second and third rows (columns: Solution Resource_identification and Solution ResourcesLocation—database table (2000) of FIG. 20). For each parameter of this line there are two parts (Second Page|C:/resources/second_page.asp). The first one before the | is the links choice (Second Page) and it is used for the end user's selection of the application page, and the applications page is the second part of the link (C:/resources/second_page.asp). The forth line (2106), InterfaceNode=N7 is retrieved from the Interfacing column (first row) of resources table (1920) of FIG. 19. The fifth lines (2108), CanvasBGColor=Blue and the sixth line (2110), TextColor=White, are retrieved from the Settings column of resources table (1920) of FIG. 19 (first row). Finally, the last line (2112), Type=Application is retrieved from the Type column of top database table (1900) of FIG. 19 (first row).

The explanation of FIG. 21 applies to FIG. 22 and FIG. 23. FIG. 24 illustrates the resource for the solution. It differs from the previous three resources. Referring to the top of the resource for FIG. 21, FIG. 22 and FIG. 23, there is APPLICATION identification for them, and for the solution resource there is SOLUTION _identification (2405). It identifies that the resource is a solutions resource. Reviewing the fifth and sixth lines of the resource (2400). The fifth line (2410) has, Type=Solution and it is retrieved from the Type column of top database table (1900) of FIG. 19 (fourth row), and, the sixth column (2420), has the value: Applications=FirstApp; SecondApp; ThirdApp and they are retrieved from the first three rows of the Application_identification column of the top database table (1900) of FIG. 19. Once the solution resource is loaded into memory and processed, it will display the three applications that are part of it (FirstApp, SecondApp and ThirdApp), and this process is what has been just explained. This covers the creation and replication of solutions along with their replication to users, and anyone skilled in the art will be able to follow the explanations given and fully understand its functionalities.

Rendering a Solution

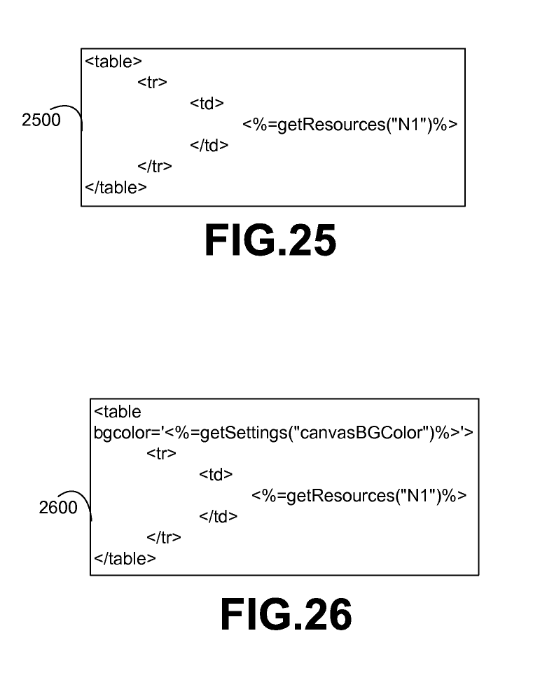

FIG. 25 illustrates the integration of an interfacing logic-node and it is retrieved from the forth line of the resource (see FIG. 21-24). An HTML page is illustrated but it can be any kind of content page. The line of code <%=getResources(N1)%> once read by the computer will call a function named getResources(N1)—it is illustrated at FIG. 7, and it has already been explained. The function will read the first line of the resource (FIGS. 21-24—PLNodes) and include the program code that was assigned as part of the application or the solution requirements (PLNodes). In this example, N1 will integrate (logically link) application (2300) of FIG. 23 (PLNodes=N1; N5) and solution (2405) of FIG. 24 (PLNodes=N1; N2).

FIG. 26 is a further embodiment of FIG. 25 and it illustrates at its first line <table bgcolor=<%=getSettings(canvasBGColor)%>> another function (not shown for simplicity) that is used to include rendering parameters at a page. As shown, the function getSettings(canvasBGColor) will read the fifth line of the resource (FIGS. 21-24) and if one is present, it will fetch its parameter and insert it into the page.

Launching a Solution

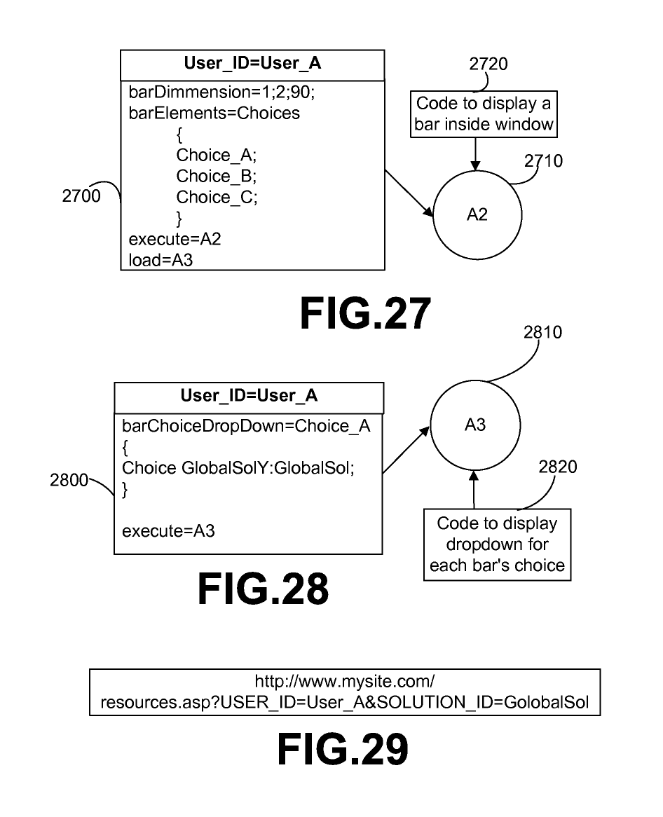

FIG. 27, FIG. 28 and FIG. 29 relate to the process of launching a solution. Once a solution has been created and replicated to a user, all that is needed is the means for launching it to an end user at a client. FIG. 27 illustrates the means for creating and displaying a menu (2700) with three choices: Choice_A, Choice_B and Choice_C. The first line has the menu-bar dimension, the second line the menu-bar choices, the third line fetches the code A2 (2710) by executing the line execute=A2 it uses its code logic (2720) to display the menu.

Lastly, after the menu choices are displayed on the screen and inside the menu-bar, the process for displaying a menu dropdown for one of its choice begins by executing the next line load=A3 and the code block A3 (2810) is executed and it has the program code-logic (2820) is used to display the menu dropdown. The menu dropdown (2800) has the choices for the Choice_A (2700) (Choice_A{Choice GlobalSolY:GlobalSol;}) and they are two solutions. Referring to Solution GlobalSol. The GlobalSol link is shown at 29 and it contains the USER_identification for the solution (USER_identification=User_A) and the solution id for the User_A and it is GlobalSol (SOLUTION _identification=GolobalSol).

After an end user at a client accesses the resources sharing container (100), it will start at a page within a folder assigned to the user's solution. The page will have all the information that is required to launch the user's solution. Once the user's solution is launched it start the process at FIG. 27, and after an end user selects the solutions link (29), the client will send the links information to the server, at the server the resources for the user's application will be created (FIGS. 21-24) and more links for the applications will be displayed, the third line of FIGS. 21-24. This is but one way of launching a solution and creating the solution's link, other means may be implemented as well without departing from the true spirit of the invention.

After a link for an application page is selected the page will be launched according to its logic-code requirements, program code-logic will be logically linked and the page will be executed. The complete process has been explained for FIGS. 21-24. Anyone skilled in the art of computer programming will be able to follow the explanations given and fully understand this invention.

Distributed Resources in the Resources Sharing Container

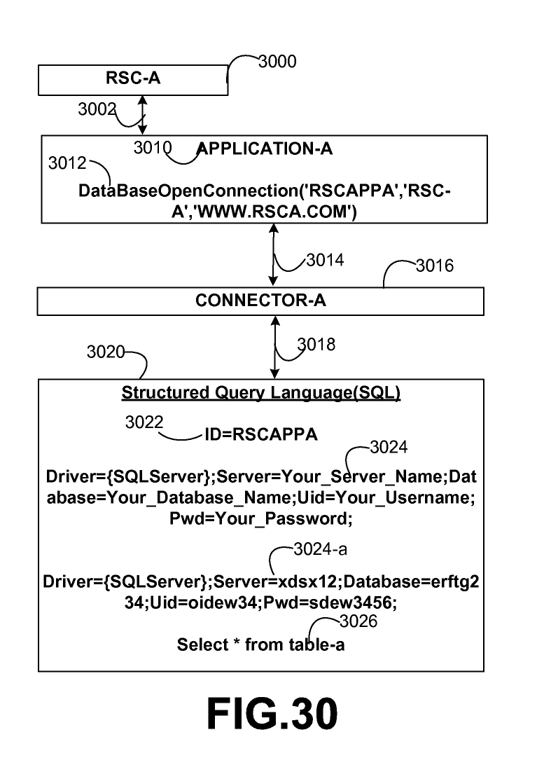

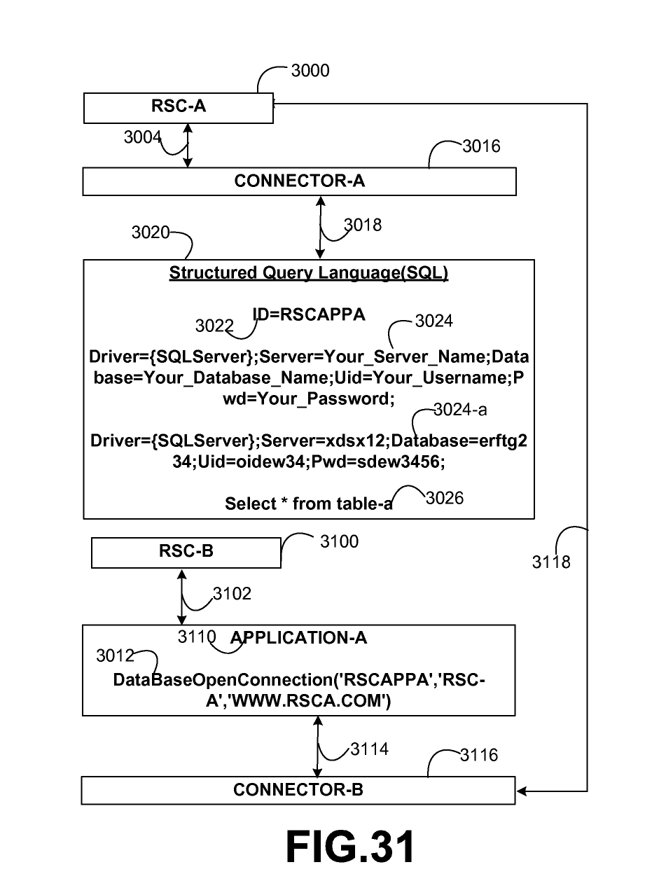

A further embodiment of the present invention is illustrated in FIG. 30 and FIG. 31 where an application hosted by the resources sharing container may have distributed logic as part of its overall logic implementation mechanism where the application-code may access other code be used by the application-code, the application-code may access string to be used by the application-code, the application-code may access instructions to be used by the application-code, the application-code may access logic to be used by the application-code, etc., from now on these code accessed by the application-code will be referred as external-code logic. The external-code logic can reside in a separate file, database table, database unit, or even at a different network (Internet) address, etc., from now on well refer these external storage-sources as external-code source.

Once the application-code logic comes upon such implementation, the application has routine-program code, or in a procedure-program code, or an object-program code, or separate code logic like a driver to deal with such external code-logic and to deal with the fetching of the external-code logic from the external-code source, from now on will be referred as retrieval-program code. The fetched external-code logic is returned to the calling retrieval-program code; next the retrieval-program code will make it available for the calling application. This mechanism allows an application to be remotely hosted (virtual host) and sensitive code logic be integrated at the parent hosting location, the location that owns the actual application. Sensitive code-logic may be for instance, database connections where the database security becomes compromised if such information is exposed to others than the applications owner. Security information like a database connection string comprising login identification and other information like the database-address' location in the network. Such information if made public definitely compromises the database's security. Any other information that may compromises security or any other kind of information deemed private may be implemented by this schema.

FIG. 30 illustrates resources sharing container, RSC-A (3000), and APPLICATION-A (3010) is associated with the RSC-A (3002). APPLICATION-A (3010) comprises a routine (3012) with parameters RSCAPPA (3022), RSC-A (3000) and WWW.RSCA.COM. The parameter RSCAPPA (3022) is the application identification; parameter RSC-A is the resources sharing containers identification and parameter WWW.RSCA.COM is the location in the network where the RSC-A (3000) resides. There is a CONNECTOR-A (3016) that is associated (represented by first arrow (3014)) with the routine (3012) and APPLICATION-A (3010). CONNECTOR-A (3016) is further associated (represented by second arrow (3018)) with an external-code source (3020). The external-code source may reside in a database or any type of storage means. The external-code source may comprise an identification of parameter (RSCAPPA (3022)) and the actual external-code source to be retrieved, first remote-code source (3024) and second remote-code source (3024-a). This is but one variation and should not be interpreted as limiting the scope of the present invention. CONNECTOR-A (3016) will further retrieve from external-code source an SQL string (3026), since in our illustration were using an example of database connection and database access, which deals with database instructions at the external-code source, but it can be used with any type of code and not necessary database related. Once CONNECTOR-A (3016) retrieves the necessary data from the external-code source, CONNECTOR-A (3016) may process the retrieved code returns the result to APPLICATION-A (3010). The invention may be implement where CONNECTOR-A (3016) simply passes retrieved data to routine (3012) and routine (3012) processes the received data and passes the result to RSC-A (3000) trough APPLICATION-A (3010).

Once a user access RSC-A (3000), RSC-A (3000) will execute APPLICATION-A (3010) and while the APPLICATION-A (3010) is being executed it will process routine (3012) and routine (3012) will pass its parameter list to CONNECTOR-A (3016). CONNECTOR-A (3016) may be part of the APPLICATION-A (3010), CONNECTOR-A (3016) may be part of RSC-A (3000) or CONNECTOR-A (3016) may be an independent program-driver (not shown). The CONNECTOR-A (3016) function as external-code logic and it communicates with the external-code source (3020) and retrieves code therefrom. Use of an SQL string in the example is but one means and not intended to be limiting. The external code may be in plain text or may be encrypted text. The CONNECTOR-A (3016) acts as a go-in-between APPLICATION-A (3010) and the external-code source (3020). The CONNECTOR-A (3016) may communicate with APPLICATION-A (3010) and external-code source (3020) or by any conceivable means, like: database connections, using XML (eXtensive Markup Language) as the transportation means between the two sources.

FIG. 31 illustrates a further embodiment of FIG. 30. In this preferred embodiment, there are two resources sharing containers: RSC-A (3000) and RSC-B (3100). Each resources sharing container is hosted at a distinct location in an internal network or on the Internet. RSC-A (3000) is the same element of FIG. 30. In this embodiment, the user accesses RSC-B (3100) and RSC-B (3100) connects (represented by sixth arrow (3102)) with a copy of the APPLICATION-A (3110) and it is the same APPLICATION-A (3010) of FIG. 30. APPLICATION-A (3110) comprises routine (3012) and it is the same routine of FIG. 30. Routine (3012) connects (represented by third arrow (3114)) to a local CONNECTOR-B (3116) passing its parameters to the connector. The connector will use the passed parameter WWW.RSC-A.COM to initiate a connection with RSC-A (3000) and pass parameters RSC-A (3000) since the location where RSC-A (3000) is hosted (www.rsca.com may host more than one resources sharing container) and will pass the parameter RSCAPPA (3022) to RSC-A (3000) and RSC-A (3000) will use the received identification of parameter RSCAPPA (3022) to fetch one of the first remote-code source (3024) or second remote-code source (3024-a). If it fetches the second remote-code source (3024-a), it will decrypt the string and uses it as a clear text string to make the database connection and fetch database objects using the database query string (3026). The CONNECTER-A (3016) in this arrangement will process the string to open database connection and fetch appropriate databases objects using an SQL string (3026). The retrieved data objects are returned (represented by fourth arrow (3004)) to RSC-A (3000) in an appropriate data envelope like a XML data envelope. RSC-A (3000) will return the data envelope (represented by fifth arrow (3118)) to the calling CONNECTOR-B (3116) and CONNECTOR-B (3116) will return (represented by third arrow (3114)) the data envelope to the originator calling routine, routine (3012), and the returned data envelope may now be used by: Routine (3012); APPLICATION-A (3110) or RSC-B (3100). CONNECTOR-B (3116) or APPLICATION-A (3110) may process the retrieved external-code source. The function parameters may change and if there is a single resources sharing container at the remote-hosting location then a parameter specifying the application identification may not be present.

An embodiment of the present invention comprises a method processed by a computer, or any kind of computing device that may include, portable computing device, server computer device, mobile computing device or any other kind of device currently available or to be later invented. The computing device hosting a resources sharing container, the computing device receiving a copy of a software application that is remotely hosted and the received copy lacking code dealing with sensitive data hosted by the remote host. The computing device storing the received copy at the resources sharing container. The copied application comprising code and a connection to connect with the remote hosting location and once the application and the connection are processed by the computing device it will cause the resources sharing container to retrieve from the remote hosting location data that is associated with the remote application without compromising the security of the remote hosting location. The resources sharing container will make the received data available to the copied application and the copied application presenting the copied applications logic and the received sensitive data to a client device.

This embodiment would, thus, be a method enabling sharing of a software logic code block from a resources sharing container with an application at runtime of the application. This method causes the software logic code block to logic link to the application based on user action to select a logic link stored in a user resource. This method includes steps of: providing a computing device, the computing device hosting a resources sharing container; receiving a copy of a software application on the computing device, the copy lacking sensitive data hosted at the remote host; storing the copy in the resources sharing container on the computing device; running the software application comprising code that causes the computing device to connect with the remote host and retrieve the sensitive data without compromising the security of the remote host; and, presenting the software application with the sensitive data to a client device.

Automatic Presentation of a Linked Application

A further embodiment is a method to enable the automatic presentation of a second application that is related to a first application that a user may link to the user's solution or to the user's application. For instance, account-payable is associated with account-receivable and once a user incorporates one the other is incorporated as well. If account-receivable is incorporate by a user at the user's application, account-payable will be incorporated as well since account-payable and the account-receivable are associated. If a user incorporates account-payable, account-receivable will be incorporated as well because of their relationship.

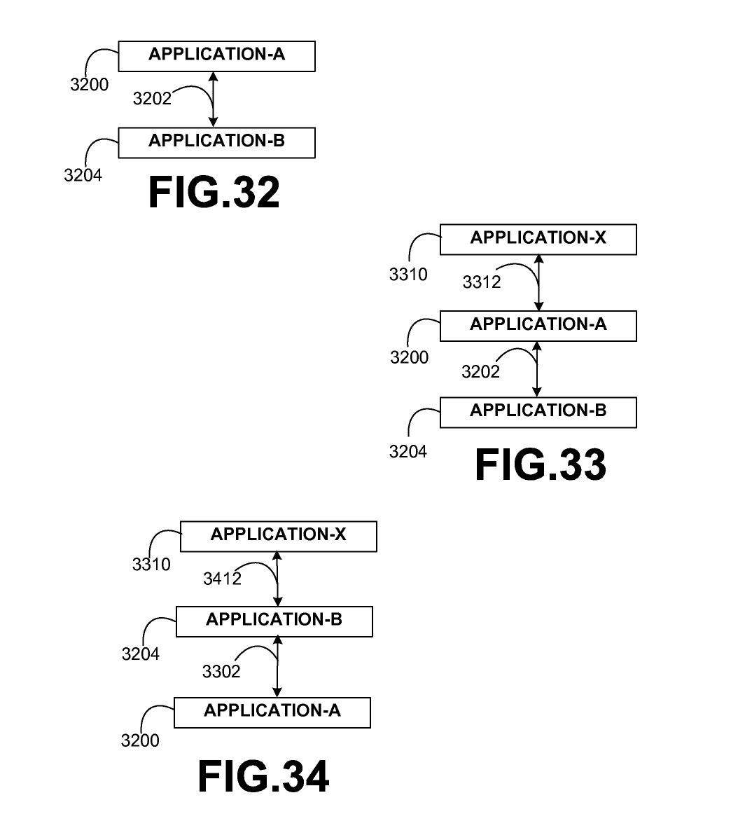

FIG. 32 illustrates APPLICATION-A (3300) and APPLICATION-B (3204) and there is an association between them (represented by seventh arrow (3202)). In FIG. 33, a user's APPLICATION-X (3310) incorporates (represented by eighth arrow (3312)) APPLICATION-A (3200). APPLICATION-B (3204) is incorporated automatically into user's APPLICATION-X (3210) as well based on the association (represented by seventh arrow (3202)) of these two applications. The user did not have to incorporate APPLICATION-B (3204) because it was automatically incorporated due to the association (represented by seventh arrow (3202)) with APPLICATION-A (3200).

FIG. 34 illustrates user incorporation (represented by ninth arrow (3412)) of APPLICATION-B (3204) into APPLICATION-X (3210), APPLICATION-A (3200) becomes associated with user's APPLICATION-X (3210) based on the association (represented by seventh arrow (3202)) regarding APPLICATION-B (3204).

Thus, a preferred method enables sharing of a software logic code block from a resources sharing container with an application at runtime of the application, the method causing the software logic code block to logic link to the application based on user action to select a logic link stored in a user resource. This method includes steps of: providing a computing device, the computing device hosting a user's application, a first software application and a second software application; creating an association between the first software application and a second software application, the association comprising a logic-link processed upon running the user's application on the computing device, the logic-link causing the first software application and the second software application to operate upon running the user's application; receiving at the computer a request to run the user's application; implementing the logic-link; and, presenting the user's application, the first software application and the second software application for display on the computer's screen.

This preferred method may alternatively comprise steps of providing a resources sharing container, a first software application and a second software application. The first software application and the second software application having an association, and the association once processed by a computing device will cause the resources sharing container to logic-link the first and the second application to a user's application even if only the first application or if only the second application is linked to the user's application. This method enables a user to logic-link the first application to the user's application. Receiving at the server computer a request to access the user's application. The request is processed by the computing device and the computing device processing the resources sharing container and the resources sharing container logic-linking the first application and the second application to the user's application, wherein the second application is automatically logic-linked to the user's application based on the association of the second application with the first application. The applications may be any kind of application that may include code to be processed by a computing device or may be contain only presentation code like HTML code.

Many more arrangements can be created and incorporated in this invention. While it has been fully described in connection with the illustrated embodiments, it will be appreciated and understood that modifications may be made without departing from the true spirit and scope of the invention. Examples of code-logic have been used and it should be recognized that any other means may be used for linking a program-code component to a page, a page to an application and an application to a solution. Furthermore, this invention will allow the creation of easy to use, low maintenance virtual replication without the overhead that other currently available solutions require.

What is claimed is:

1. A method enabling sharing of software using logic links, the method comprising the steps of:
registering, for access to a server computer, a first user and a second user;
receiving from the first user: a first-user application; a first-user-application page; and a first-user-application parameter;
providing:
the server computer, the server computer comprising memory, the memory comprising a non-transitory computer-readable medium; and
a resources sharing container stored in the memory, the resources sharing container comprising:
a solution resource, the solution resource comprising:
a plurality of solutions able to integrate and run the first-user application, and a first-user-solution parameter; and
an application resource, the application resource comprising: the first-user application; the first-user-application parameter; and the first-user application page;
running a first solution in the plurality of solutions upon action of the first user, said running controlled by the first-user-solution parameter;
adding a logic link to the first-user-application within the first solution upon a request from the first user;
causing to run within the first solution and on the server computer the first-user application subject to the first-user-application parameter and the first-user application page, said causing initiated by first-user action to select said logic link within the first solution;
enabling the second user to add a second-user-solution parameter to the solution resource to govern how the second solution is run;
running the second-user solution upon action of the second user, said running controlled by the first-user-solution parameter if no second-user-solution parameter is present, or by the second-user-solution parameter if the second-user-solution parameter is present in the solution resource;
adding the logic link to the first-user-application within a second-user solution in the plurality of solutions upon a request from the second user; and
causing to run within the second solution and on the server computer the first-user application subject to the first-user-application parameter and the first-user application page, said causing initiated by second-user action to select said logic link within the second solution.

2. A method enabling sharing of a software logic code block from a resources sharing container with an application at runtime of the application, the method causing the software logic code block to logic link to the application based on user action to select a logic link stored in a user resource, the method comprising the steps of:
providing a computer, the computer comprising memory, the memory comprising a non-transitory computer-readable medium;
registering a user with the computer;
assigning the user a user identification stored on the computer-readable medium;
creating a resources sharing container on the computer-readable medium, the resources sharing container comprising: a software logic code block, a user resource, an application, and an application software page used with the application;
the user resource comprising a logic link that connects the software logic code block to the application software page at runtime of the application so that the application will execute the software logic code block at runtime of the application software page;
giving the user a choice to connect or disconnect the logic link, such that if the logic link:
is disconnected, the application will not execute the software logic code block at runtime of the application; and the choice is stored and associated with the user identification in the user resource; and
is connected, the application will execute the software logic code block at runtime of the application; and the choice is stored and associated with the user identification in the user resource;
accessing the user resource associated with the user identification and if the logic link is connected, then executing the logic link of the software logic code block to the application software page upon the user launching of the application and upon the user running of the application software page; and
presenting to the user a result from executing the logic link, upon executing the logic link.

3. A method enabling sharing of a software logic code block from a resources sharing container with an application at runtime of the application, the method causing the software logic code block to logic link to the application based on user action to select a logic link stored in a user resource, the method comprising the steps of:
providing a computing device, the computing device hosting a user's application, a first software application and a second software application;
creating an association between the first software application and a second software application, the association comprising a logic-link processed upon running the user's application on the computing device, the logic-link causing the first software application and the second software application to operate upon running the user's application;
receiving at the computer a request to run the user's application;
implementing the logic-link; and,
presenting the user's application, the first software application and the second software application for display on the computer's screen.

4. A method enabling sharing of a software logic code block from a resources sharing container with an application at runtime of the application, the method causing the software logic code block to logic link to the application based on user action to select a logic link stored in a user resource, the method comprising the steps of:
providing a computing device, the computing device hosting a resources sharing container;
receiving a copy of a software application on the computing device, the copy lacking sensitive data hosted at the remote host;
storing the copy in the resources sharing container on the computing device;
running the software application comprising code that causes the computing device to connect with the remote host and retrieve the sensitive data without compromising the security of the remote host; and,
presenting the software application with the sensitive data to a client device.
